(19) United States
(12) Patent Application Publication
(10) Pub. No.: US 2024/0278136 A1
(43) Pub. Date: Aug. 22, 2024

(54) ELECTRONIC DEVICE AND METHOD FOR PROVIDING INFORMATION RELATED TO GAMES

(71) Applicant: GGQ COMPANY INC., Seoul (KR)

(72) Inventors: Min Seo KIM, Seoul (KR); Yong Su LEE, Seoul (KR)

(21) Appl. No.: 18/569,069

(22) PCT Filed: Jun. 14, 2022
(86) PCT No.: PCT/KR2022/008389

§ 371 Date: Dec. 11, 2023

(30) Foreign Application Priority Data
Jun. 16, 2021 (KR) 10-2021-0078059

(51) Int. Cl. A63F 13/795; A63F 13/35; A63F 13/537; A63F 13/798

(52) U.S. Cl. CPC A63F 13/795; A63F 13/35; A63F 13/537; A63F 13/798

(57) ABSTRACT

Disclosed is an operation method of a server for providing information related to a game. The operation method includes the steps of acquiring first statistical information related to match records of a plurality of first users who use a team match game, receiving, from a first application, a user input related to preliminary operations for a user to prepare for a match, acquiring second statistical information related to match records of second users who have participated in the match, generating, on the basis of the first statistical information, configuration information personalized to the user of the first application, generating, on the basis of the second statistical information, additional information regarding a match team with which the user has matched, providing control information for controlling a game client to a second application on the basis of the user input, and providing at least one of the personalized configuration information and the additional information to the second application.

### TECHNICAL FIELD

The present disclosure relates to a method and server for providing information related to games to users.

### BACKGROUND ART

With the development of computing devices and network environments, the number of users who enjoy online-based games using various wired and wireless communication devices is increasing. In particular, in an online team match game in which a plurality of users forms a team and battle an opposing team, each of the plurality of users can select a different game character and form a team. Since users matched in each match are different and there are various types of game characters that can be selected in a match, different situations occur in matches.

Therefore, a user can apply appropriate settings to the current match before the match begins in consideration of the synergy of game characters of the team to which the user belongs, compatibility with game characters of the opposing team, and the like, but it is difficult to apply optimal settings considering numerous variables for each match.

Therefore, there is a need for a technology for providing information related to game settings to users such that users participating in a match can conveniently apply personalized configuration information.

### DISCLOSURE

### Technical Problem

It is an object of the present disclosure to provide a remote setting function for providing information related to game settings to a user such that the user can apply game-related settings and allowing the user to remotely apply game-related settings using a device of the user.

### Technical Solution

In accordance with the present invention, the above and other objects can be accomplished by the provision of an operating method of a server, including obtaining first statistical information related to match records of a plurality of first users using a team match game, receiving, from a first application, user input related to preliminary operations performed by a user to prepare for a match, obtaining second statistical information related to match records of second users participating in the match, generating configuration information personalized to the user of the first application on the basis of the first statistical information, generating additional information regarding a match team with which the user is matched on the basis of the second statistical information, providing control information for controlling a game client to a second application on the basis of the user input, and providing at least one of the personalized configuration information or the additional information to the second application.

In accordance with another aspect of the present invention, there is provided a server including a communication interface, a processor, and a memory in which instructions executable by the processor are stored, wherein the processor is configured to, by executing the instructions, obtain first statistical information related to match records of a plurality of first users using a team match game, receive, from a first application, user input related to preliminary operations performed by a user to prepare for a match, obtain second statistical information related to match records of second users participating in the match, generate configuration information personalized to the user of the first application on the basis of the first statistical information, generate additional information regarding a match team with which the user is matched on the basis of the second statistical information, provide control information for controlling a game client to a second application on the basis of the user input, and provide at least one of the personalized configuration information or the additional information to the second application.

In accordance with a further aspect of the present invention, there is provided an electronic device including a communication interface, a processor, and a memory in which instructions executable by the processor are stored, wherein the processor is configured to, by executing the instructions, execute a game client providing a team match game on the electronic device, receive, from a server, personalized configuration information indicating parameters set by a user to participate in a match and additional information regarding a match team to which the user is matched, wherein the personalized configuration information is generated based on first statistical information related to match records of a plurality of first users using the team match game, and the additional information is generated based on second statistical information related to match records of second users who have participated in the current match in which the user has participated, display the personalized configuration information and the additional information, and control the game client such that the personalized configuration information is applied to the game client.

### Advantageous Effects

The server according to the disclosed embodiment can provide game-related information such that a user playing a team match game can apply appropriate settings to the current match before the match begins, and provide the convenience of user settings for allowing the user to apply settings by remotely controlling an electronic device through which the game is executed using a user device.

### DESCRIPTION OF DRAWINGS

FIG. 1 is a diagram illustrating a system in which a server provides services related to an online game according to an embodiment.

FIG. 2 is a flowchart illustrating a method by which the server manages operations of a first application and a second application according to an embodiment.

FIG. 3 is a diagram illustrating an example of personalized configuration information generated by the server on the basis of first statistical information according to an embodiment.

FIG. 4 is a diagram illustrating an example of additional information generated by the server on the basis of second statistical information according to an embodiment.

FIG. 5 is a diagram illustrating a method by which the server obtains authentication information from a user in order to control the first application and the second application according to an embodiment.

FIG. 6 is a diagram illustrating a method by which the server generates location information for displaying the second application on a second electronic device according to an embodiment.

FIG. 7 is a diagram illustrating a method by which the server generates personalized configuration information on the basis of a game mode according to an embodiment.

FIG. 8 is a diagram illustrating a method by which the server generates personalized configuration information according to an embodiment.

FIG. 9 is a diagram illustrating a method by which the server provides a user with information on team members who can participate in the same team as the user according to an embodiment.

FIG. 10 is a diagram illustrating the first application managed by the server according to an embodiment.

FIG. 11 is a block diagram of the server according to an embodiment.

### BEST MODE

The terms used in this specification will be briefly described and the present invention will be described in detail.

Although most terms used in this specification have been selected from general ones currently widely used in the art taking into consideration functions thereof in this specification, the terms may be changed depending on the intention or convention of those skilled in the art or the introduction of new technology. Some terms have been arbitrarily selected by the applicant and their meanings are explained in the following description as needed. Thus, the terms used in this specification should be construed based on the overall content of this specification together with the actual meanings of the terms rather than their simple names or meanings.

The singular expression includes the plural expression unless the context clearly dictates otherwise. All terms including technical or scientific terms have the same meanings as generally understood by a person having ordinary skill in the art to which the present invention pertains. Additionally, terms including ordinal numbers, such as “first” and “second”, used in this specification may be used to describe various components, but the components should not be limited by the terms. The above terms are used only for the purpose of distinguishing one component from another.

When it is said that a part “includes” a certain component throughout the specification, this means that, unless specifically stated to the contrary, it does not exclude other components but may further include other components. Additionally, terms such as “unit” or “module” used in the specification refer to a unit that processes at least one function or operation, which may be implemented as hardware or software, or as a combination of hardware and software.

Hereinafter, embodiments of the present invention will be described in detail with reference to the attached drawings such that those skilled in the art can easily implement the present invention. However, the present invention may be implemented in many different forms and is not limited to the embodiments described herein. In order to clearly describe the present invention in the drawings, parts that are not related to the description are omitted, and similar parts are given similar reference numerals throughout the specification.

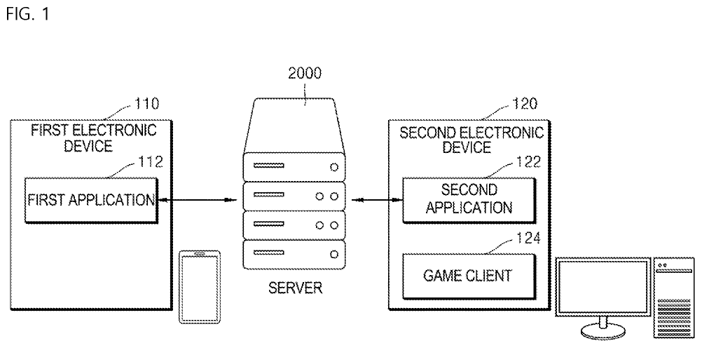

FIG. 1 is a diagram illustrating a system in which a server provides services related to an online game according to an embodiment.

In the disclosed embodiment, the online game may be a team match game in which a plurality of users forms a team and plays against an opposing team. In this case, the online game may be a game that provides a preliminary team composition stage in which a plurality of users prepares settings for use in a match in which they participate before the plurality of users starts the match. For example, the online game may be a team match game, such as “League of Legends”, in which a plurality of users forms different teams and compete against each other. Here, a team match game may be a game in which one team wins by destroying the camp of the other team. Hereinafter, for convenience of description, in describing the disclosed embodiments, “League of Legends”, which is a team match game, will be described as an exemplary online game. However, the disclosed embodiments are not limited thereto and the disclosed embodiments may be applied to team match type online games that provide a preliminary team composition stage.

A server 2000 according to an embodiment may provide users with services related to online games. In the disclosed embodiment, services related to an online game refers to services for providing convenience to a user of the online game by assisting preliminary operations of the user when the user performs a series of preliminary operations to prepare for participating in a match. For example, to participate in a match, a user of an online game may perform preliminary operations of searching for a new match and setting various parameters to be used in the match in a preliminary team composition stage for participating in the match. In order to assist preliminary operations of a user, the server 2000 may provide services for providing various information related to a match to the user and completing settings.

The server 2000 according to an embodiment may provide services related to the online game to the user by managing and controlling a first application 112 and a second application 122 installed in a plurality of electronic devices used by the user of the online game. In this case, the first application 112 may be installed in a first electronic device 110 used by the user, and the second application 122 may be installed in a second electronic device 120 used by the user.

In the disclosed embodiment, the first electronic device 110 may include various electronic devices used by the user to remotely control the online game. For example, the first electronic device 110 may include, but is not limited to, a smartphone, a tablet, a desktop computer, a laptop computer, etc.

In the disclosed embodiment, the second electronic device 120 may include various electronic devices used by the user to play the online game. For example, the second electronic device 120 may include, but is not limited to, a desktop computer, a laptop computer, a video game console, etc.

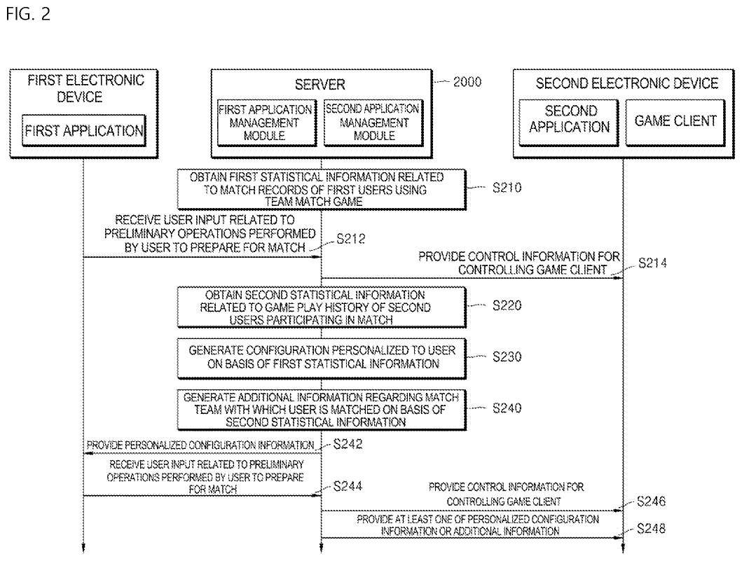

The first application 112 of the first electronic device 110 managed by the server 2000 according to an embodiment may provide functions by which the user remotely performs preliminary operations performed by the user before participating in a match by using the first electronic device and remotely controls the second electronic device 120 for playing the game. The server 2000 may receive user input related to preliminary operations performed by the user to prepare for a match from the first application 112. Specific information included in the user input received by the server 2000 according to an embodiment from the first application 112 will be further described with reference to FIG. 2.

The second application 122 of the second electronic device 120 managed by the server 2000 according to an embodiment may control a game client 124 on the basis of information received from the server 2000. In addition, the second application may display information for the user on a screen area other than the screen area in which the game client 124 is displayed on the display of the second electronic device 120 when the game client 124 is executed in the second electronic device 120.

In the disclosed embodiment, the game client 124 refers to another application provided by an online game provider to run the online game. The server 2000 may allow the second application 122 to control the game client 124 by providing control information for controlling the game client 124 to the second application 122. The operation of the server 2000 to provide game-related services to the user using the first application 112 and the second application 122 will be further described with reference to FIG. 2.

FIG. 2 is a flowchart illustrating a method by which the server manages operations of the first application and the second application according to an embodiment.

In describing FIG. 2, for convenience of explanation, “League of Legends”, which is a team match game, will be described as an exemplary online game, and a game character will be referred to as a “champion.”

In the disclosed embodiment, the server 2000 may perform operations related to the first application and operations related to the second application, which will be described later, using a first application management module and a second application management module.

In step S210, the server 2000 according to an embodiment may obtain first statistical information related to match records of a plurality of first users using a team match game.

In the disclosed embodiment, the first statistical information may be information obtained from records of a plurality of matches in which a plurality of users has participated. The server 2000 according to an embodiment may obtain a plurality of match records from a game server of a game provider, process information included in the obtained match records, generate the first statistical information, and store the first statistical information in a storage within the server.

The first statistical information may include various types of information representing indicators related to a team match game. For example, the first statistical information may include at least one of a win rate of a specific champion, which represents the ratio of matches in which the specific champion participated and which the team of the specific champion won (hereinafter, a win rate), among matches played by a plurality of users in the past (hereinafter, past matches), the ratio of matches in which the specific champion participated by being selected by a user among the past matches and the ratio of matches in which the specific champion was unable to participate by being banned from participation by a user among the past matches (hereinafter, a pick/ban ratio), the number of times the specific champion participated in matches (hereinafter, the number of plays), a time taken for matches in which the specific champion participated (hereinafter, a play time), a rating that represents the ratio of kills and assists which are scoring factors of the specific champion and deaths which are losing factors (hereinafter, rating), a champion skill level (hereinafter, skill level) which is calculated based on the play time and the number of plays of the specific champion, a position representing a role of the specific champion in a match (hereinafter, in-game position), an item used in the play of the specific champion (hereinafter, used item), or rune and spell which are parameters indicating characteristics set for the play of the specific champion (hereinafter, rune and spell). However, the first statistical information is not limited thereto and may include various types of information regarding game-related indicators recorded depending on game play of users in the online team match game.

In the disclosed embodiment, a “first user” refers to a specific group created by the server 2000 by grouping a plurality of users based on a predetermined standard. For example, the first user may refer to the entire user group, a user group belonging to a specific tier, or a user group playing a specific position. In this case, “tier” may be an indicator indicating a user's level of skill in an online game. An online game may be a game with a ranking system in which a user plays the online game and is given points based on whether the user wins or loses and is given a tier indicating the user's level of skill. For example, in the case of “League of Legends”, a user can be disposed on a tier such as iron, bronze, silver, gold, platinum, diamond, master, grandmaster, or challenger depending on the user's gaming skill. In addition, “position” may represent a role to be played in a team when a user forms the team to participate in an online game. For example, in “League of Legends”, a user can participate in matches in a position such as top, mid, jungle, ranged dealer, or supporter.

The server 2000 according to an embodiment may determine first users corresponding to a user group for which statistical information is to be obtained in order to generate configuration information personalized to a user. The server 2000 may obtain the first statistical information related to match records of the determined first users.

In the disclosed embodiment, game environment setting information may be environment setting information for a game that the user frequently uses when playing the game. For example, game environment setting information may include in-game environment setting variables (e.g., a mouse cursor size, the position and size of an in-game interface, etc.). In another example, game environment setting information may include information on setting values of input/output devices (e.g., mouse sensitivity, cursor movement speed, game resolution, frames per second, sound output magnitude, etc.). The server 2000 may receive game environment setting information from the user and store the same in the server 2000. Additionally, the server 2000 may obtain game environment setting information that was applied when the user played the game and store the same in the server even if there is no additional input from the user.

In step S212, the server 2000 according to an embodiment may receive user inputs related to preliminary operations for the user to prepare for a match from the first application. For example, the server 2000 may receive a user input for inviting team members to participate in a match, a user input for searching for a new match to participate in a match, and the like from the first application. Additionally, the server 2000 may receive information on in-game environment setting variables and setting values of input/output devices from the first application.

The operation of step S212 may be repeatedly performed each time the user inputs a command using the first application. For example, the operation of step S244 may be an operation of receiving a different user input from the first application when a command different from the command input by the user in step S212 is input.

In step S214, the server 2000 according to an embodiment may provide control information for controlling the game client to the second application on the basis of the received user inputs. For example, when the server 2000 receives a user input for inviting a team member to participate in a match from the first application, the server 2000 may provide control information for the second application to control the game client to invite a team member within the game client to the second application. In another example, when the server 2000 receives a user input for searching for a new match to participate in the match from the first application, the server 2000 may provide control information for the second application to control the game client to search for a match within the game client to the second application. In another example, when the server 2000 receives a game environment setting information input of the user from the first application, the server 2000 may provide control information for the second application to control the game client and the second electronic device to the second application. In another example, in a case in which the user has no history of playing a game through the second electronic device (for example, in a case in which the user plays a game on a new second electronic device that is different from the previously used second electronic device), the server 2000 may provide control information for the second application to control the game client and the second electronic device on the basis of game environment setting information stored in the server 2000 to the second application even if there is no separate input from the first application.

The operation of step S214 may be repeatedly performed each time a user input is received from the first application. For example, the operation of step S246, which will be described later, may be an operation of providing different control information to the second application when a different user input is received from the first application in step S214.

In step S220, the server 2000 according to an embodiment may obtain second statistical information related to match records of second users who have participated in matches.

In the disclosed embodiment, the online game may be a game that provides a preliminary team composition step in which users can prepare settings for use in a match in which the users will participate before the match begins when the user participates in the match. In the disclosed embodiment, the server 2000 may receive another user input from the first application in the preliminary team composition stage. For example, when the server 2000 receives a user input for selecting a champion to be banned from participating in a match from the first application, the server 2000 provides control information for the second application to control the game client such that the champion can be banned from participating in the match within the game client to the second application. In the same manner, the server 2000 may receive a user input for selecting a champion to be used in a match from the first application and provide control information corresponding to the received input to the second application.

In the disclosed embodiment, the second statistical information obtained by the server 2000 may be acquired in the preliminary team composition stage after the user participates in the match and before the match begins. Further, the second users may be users who have participated in the same match as the user.

The second statistical information may include various types of information representing game-related indicators obtained from past match records of second users who have participated in the match. For example, the second statistical information may include at least one of a champion used by a second user, the tier, in-game rating, win rate, skill level, or in-game position of the second user.

In step S230, the server 2000 according to an embodiment may generate configuration information personalized to the user on the basis of the first statistical information obtained in step S210. In addition, the server 2000 may obtain user statistical information related to match records of the user and generate personalized configuration information indicating parameters set by the user to participate in the match on the basis of the first statistical information and the user statistics information.

In one embodiment, the server 2000 may obtain game profile information of the user. In this case, the game profile information of the user may include at least one of the game tier of the user, the champion that the user mainly plays, champion's rune, spell, or the in-game position of the user.

In one embodiment, when the user enters the preliminary team composition stage, the server 2000 may identify the position at which the user is disposed in the match and generate champion recommendation information for recommending at least one champion to be selected by the user to participate in the match as configuration information personalized to the user on the basis of the identified position and the game profile information of the user.

In one embodiment, the server 2000 may determine a plurality of first users having characteristics similar to those of the user on the basis of the game profile information of the user and generate configuration information personalized to the user on the basis of the first statistical information of the determined first users. For example, if the in-game tier of the user is the gold tier, the server 2000 may determine other users belonging to the same tier as the user, that is, gold tier users, as the first users. In another example, if the in-game position of the user is the jungle position, the server 2000 may determine users in the jungle position, which are other users participating in the match in the same position as the user, as the first users.

In one embodiment, when the user enters the preliminary team composition stage, the server 2000 may identify champions selected by second users who are members of the match team with which the user is matched, and generate champion recommendation information for recommending at least one champion to be selected by the user to participate in the match on the basis of the identified champions selected by the second users and the game profile information of the user as personalized configuration information.

In one embodiment, when the user selects a specific champion in the preliminary team composition stage, the server 2000 may generate configuration information personalized to the user corresponding to the selected champion. For example, when the user selects champion “A”, the server 2000 may generate personalized configuration information that can be used to set rune and spell of champion “A” on the basis of first statistical information regarding matches in which the first users participated using champion “A”. In this case, the server 2000 may change at least part of the personalized configuration information generated based on the first statistical information on the basis of the profile information of the user. Additionally, the server 2000 may generate skill and item information regarding champion “A” on the basis of at least one of the first statistical information or the user profile information.

In step S240, the server 2000 according to an embodiment may generate additional information on the match team with which the user is matched on the basis of the second statistical information.

In one embodiment, the server 2000 may generate additional information including at least one of the champions that the second users played in the N most recent games (N being an integer of 1 or more), whether the second users won or lost, ratings, tiers, win rates, or the numbers of matches of the second users on the basis of at least one of the champions used by the second users, in-game ratings, win rates, skill levels, or in-game positions of the second users included in the second statistical information of the second users included in the match team with which the user is matched. In addition, the server 2000 may generate additional information including at least one of whether the champion selected by a second user is the main champion, the champion skill level of the second user, change in the tier of the second user, or whether the in-game position at which the second user is disposed is the main position of the second user. The server 2000 may predict a win rate of the match in which the user participates in the preliminary team composition stage on the basis of the generated additional information and guide the user to decide whether to forfeit the match.

In step S242, the server 2000 according to an embodiment may provide the personalized configuration information generated in step S230 to the first application. In this case, the user may check the personalized configuration information generated by the server 2000 and input a command for confirming the personalized configuration information or changing at least part of the personalized configuration information using the first application.

In step S244, the server 2000 according to an embodiment may receive a user input related to preliminary operations for the user to prepare for a match from the first application. For example, the server 2000 may receive a user input for changing/confirming the above-described personalized configuration information in step S242. In this case, the user input for changing/confirming the personalized configuration information may be an input for changing and confirming at least some of the rune, spell, characteristics, or skins corresponding to the champion selected by the user included in the personalized information or confirming without changing the same.

In step S246, the server 2000 according to an embodiment may provide control information for providing a game client to the second application.

For example, when the server 2000 receives a user input for changing/confirming personalized configuration information from the first application, the server 2000 may provide control information for the second application to control the game client such that the personalized configuration information can be changed/confirmed within the game client to the second application.

In step S248, the server 2000 according to an embodiment may provide at least one of the personalized configuration information or the additional information to the second application.

In one embodiment, the personalized configuration information may be included in the control information provided to the second application in step S246 such that the second application can automatically apply the personalized configuration information by controlling the game client.

In one embodiment, at least one of the personalized configuration information or the additional information may be visualized and provided to the user through the second application. In this case, the second application visualizes and displays the personalized configuration information and the additional information in an area other than the area in which the game client is displayed on the display of the second electronic device such that the user can guide game play before the match begins in the preliminary team composition stage.

The server 2000 according to the disclosed embodiment may allow the user who plays the game using the game client executed in the second electronic device to perform preliminary operations for prepare for the match using the first application of the first electronic device in the preliminary team composition stage before the start of the match.

Additionally, the server 2000 according to the disclosed embodiment may control the game client executed in the second electronic device using the second application of the second electronic device.

Further, the server 2000 according to the disclosed embodiment may visually provide at least one of personalized configuration information or the additional information regarding the match in which the user participates on the display of the second electronic device using the second application of the second electronic device.

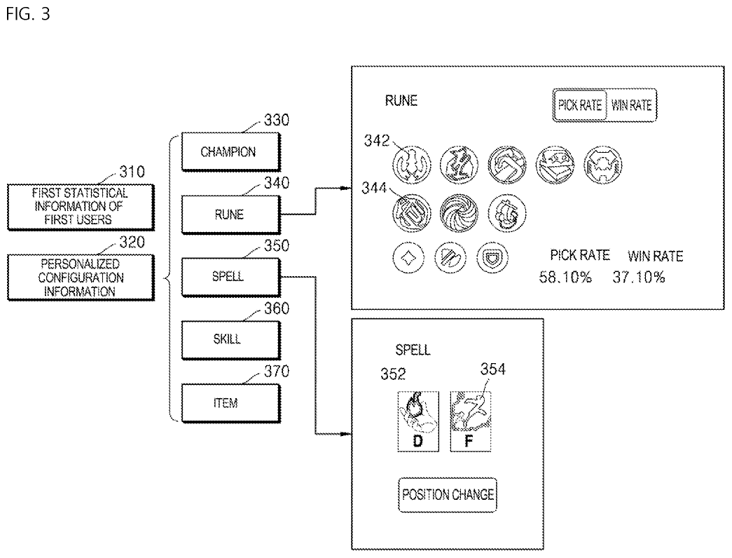

FIG. 3 is a diagram illustrating an example of personalized configuration information generated by the server on the basis of first statistical information according to an embodiment.

In describing FIG. 3, for convenience of explanation, “League of Legends”, which is a team match game, will be described as an exemplary online game, and a game character will be referred to as a “champion”.

The server 2000 according to an embodiment may generate personalized configuration information 320 indicating parameters set by a user to participate in a match on the basis of first statistical information 310 of first users. The first statistical information 310 includes, for example, at least one of information on a specific champion, that is, win rate, pick/ban ratio, number of plays, play time, rating, skill level, in-game position, used items, rune, or spell. Additionally, the server 2000 according to an embodiment may generate personalized configuration information by further using game profile information of the user. The user profile information may include, for example, at least one of the champion that the user mainly plays, the champion's rune, spell, or in-game position of the user.

The personalized configuration information 320 may include at least one of champion-related information 330, rune-related information 340, spell-related information 350, skill-related information 360, or item-related information 370.

In one embodiment, the champion-related information 330 in the personalized configuration information 320 may be information for recommending at least one champion to be selected by the user to participate in the match. Since specific embodiments of recommending a champion have been described in the description with reference to FIG. 2, description thereof will be omitted.

In one embodiment, the rune-related information 340 in the personalized configuration information 320 may include information on the rune to be set for the champion selected by the user. For example, the server 2000 may generate information related to the rune to be set for the champion selected by the user using a combination of various characteristics. Specifically, in the case of the “League of Legends” game, “rune” provides characteristics such as “inspiration”, “dominance”, “precision”, “resolution”, and “magic”, and the user can select two characteristics to be set for the champion. Accordingly, the server 2000 may generate rune-related information by setting a first characteristic 342 as “dominance” and setting a second characteristic 344 as “inspiration”. The server 2000 may generate rune-related information including information such as the selection rate of the corresponding rune and the win rate of the corresponding rune on the basis of the first statistical information 310.

In one embodiment, the spell-related information 350 in the personalized configuration information 320 may include information on the spell to be set for the champion selected by the user. For example, in the case of “League of Legends”, “spell” provides “flash”, “ignite”, “heal”, “teleport”, and “recapture”, and the user can select two spells to be set for the champion. Accordingly, the server 2000 can generate the spell-related information 350 by combining different spells. Specifically, the spell-related information generated by the server 2000 may be obtained by combining “ignite” as the first spell 352 and “flashing” as the second spell 354.

In one embodiment, the skill-related information 360 in the personalized configuration information 320 may include information on the skill of the champion selected by the user. For example, in the case of “League of Legends”, there may be four skills that can be used by one champion, and the user can strengthen the champion by investing skill points in any one of the four skills whenever the level of the champion increases in the match. In this case, the skill-related information 360 may include a skill mastery order of the champion selected by the user.

In one embodiment, the item-related information 370 in the personalized configuration information 320 may include information on items used by the champion selected by the user. For example, in the case of “League of Legends”, the user can strengthen the champions by acquiring gold in the match and purchasing items to be equipped by the champion with the acquired gold. In this case, the item-related information 370 may include the item type and purchase order of the champion selected by the user.

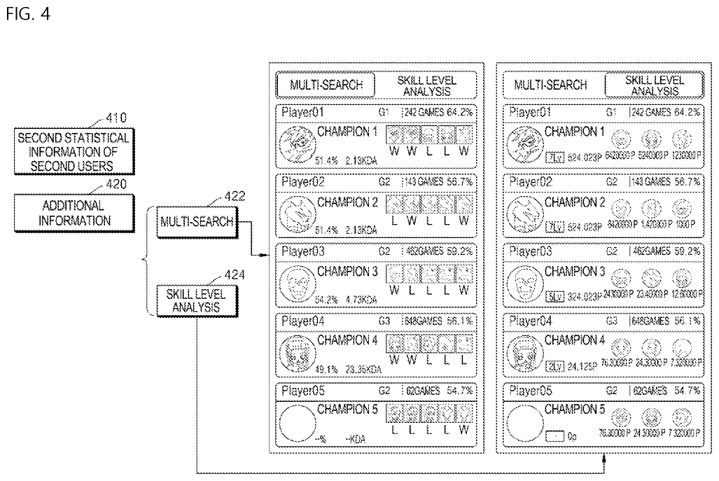

FIG. 4 is a diagram illustrating an example of additional information generated by the server on the basis of the second statistical information according to an embodiment.

In describing FIG. 4, for convenience of explanation, “League of Legends”, which is a team match game, will be described as an exemplary online game, and a game character will be referred to as a “champion”.

The server 2000 according to an embodiment may generate additional information regarding a match team with which a user is matched, on the basis of second statistical information of second users. The second statistical information may include, for example, at least one of the champion used by a second user, the tier, in-game rating, win rate, skill level, or in-game position of the second user.

Additional information 420 according to an embodiment may include at least one of multi-search information 422 or skill level analysis information 424.

In one embodiment, the server 2000 may generate the multi-search information 422 obtained by searching for profile information of second users who are team members of the match in which the user has participated on the basis of second statistical information 410. For example, the multi-search information 422 may include at least one of the champion that a second user played in N recent games, whether the second user won or lost, the rating, tier, win rate, or the number of matches of the second user.

In one embodiment, the server 2000 may generate the skill analysis information 424 obtained by analyzing the game skill level of a second user, who is a team member matched to the match in which the user has participated on the basis of the second statistical information 410. For example, the skill level information 424 may include at least one of whether the champion selected by a second user is a main champion, the champion skill level of the second user, change in the tier of the second user, or whether the in-game position at which the second user is disposed is a main position.

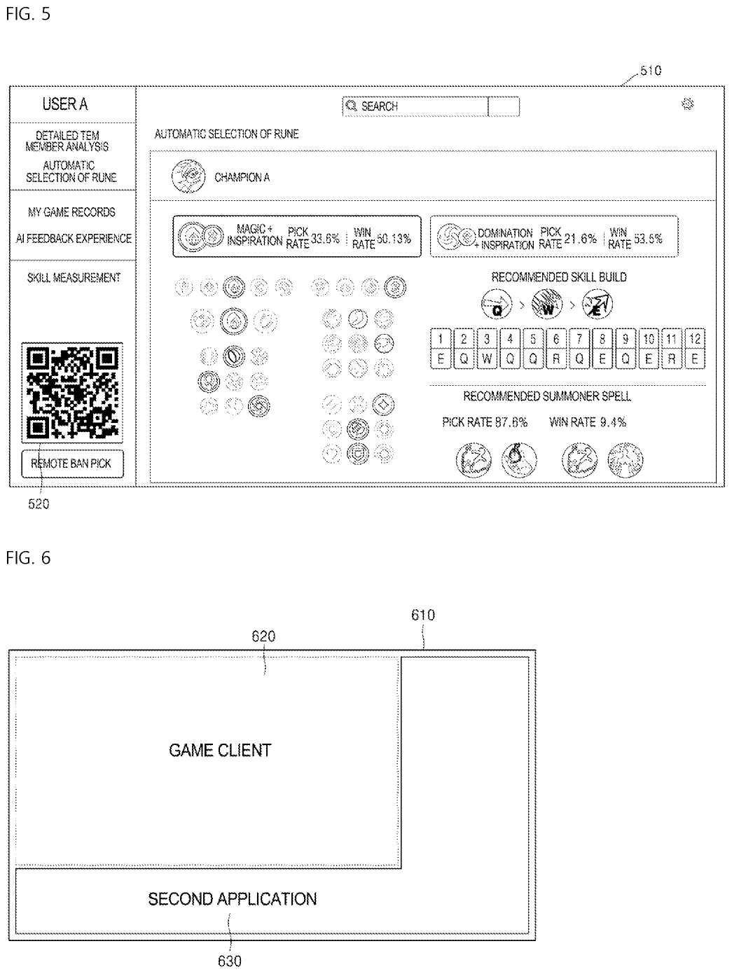

FIG. 5 is a diagram illustrating a method by which the server obtains authentication information from a user in order to control the first application and the second application according to an embodiment. In describing FIG. 5, for convenience of explanation, “League of Legends”, which is a team match game, will be described as an exemplary online game.

The server 2000 according to an embodiment may perform a user authentication procedure to allow the user to control the second application of the second electronic device using the first application of the first electronic device.

In one embodiment, the server 2000 may link the first application executed in the first electronic device for an unregistered user using a user authentication means included in an execution screen 510 of the second application executed in the second electronic device. For example, the server 2000 may provide information related to a QR code to the second application such that the QR code 520 is displayed on the execution screen 510 of the second application. When the user captures the QR code 520 displayed on the execution screen 510 of the second application using the first electronic device, the server 2000 may link the first application by receiving authentication information corresponding to the QR code from the first application and authenticating the first electronic device.

In one embodiment, the server 2000 may link the first application for a registered user by receiving authentication information of an account logged in by the user from the first application and authenticating the first electronic device.

When the first application of the first electronic device and the second application of the second electronic device are linked, the server 2000 according to an embodiment may receive user inputs related to preliminary operations for the user to prepare for the match, which are input through the first electronic device, from the first application. The server 2000 may provide control information for controlling the game client to the second application on the basis of the received user inputs such that the user can remotely control the game client executed in the second electronic device using the first electronic device.

FIG. 6 is a diagram illustrating a method by which the server generates location information for displaying the second application on the second electronic device according to an embodiment.

The server 2000 according to an embodiment may obtain location information (e.g., coordinate information) of a game client 620 displayed on a display 610 of the second electronic device.

In one embodiment, the server 2000 may generate location information the second application 630 for displaying the second application on the display 610 of the second electronic device on the basis of the obtained location information of the game client 620.

For example, when the game client 620 is displayed in the upper left corner of the display 610 of the second electronic device, the server 2000 may generate location information of the second application 630 for displaying the second application 630 such that the second application 630 is not displayed overlapping the game client 620 on the basis of the location information of the game client 620 displayed on the display 610 of the second electronic device. In this case, the second application 630 may be displayed on the lower right of the game client 620.

The server 2000 according to an embodiment may acquire the location information of the game client 620 displayed on the display 610 of the second electronic device in real time, and generate location information of the second application 630 such that the second application 630 is displayed depending on a changed location of the game client whenever the location of the game client 620 changes.

Personalized configuration information and additional information generated from the server 2000 according to the above-described embodiments may be displayed in the second application.

The server 2000 according to an embodiment can prevent the second application 630 from being displayed overlapping the game client 620 by generating location information of the second application 630 on the basis of the location information of the game client 620 and providing the generated location information of the second application 630 to the second application, and visually provide game-related information to the user by allowing the second application 630 to be displayed simultaneously with the game client 620.

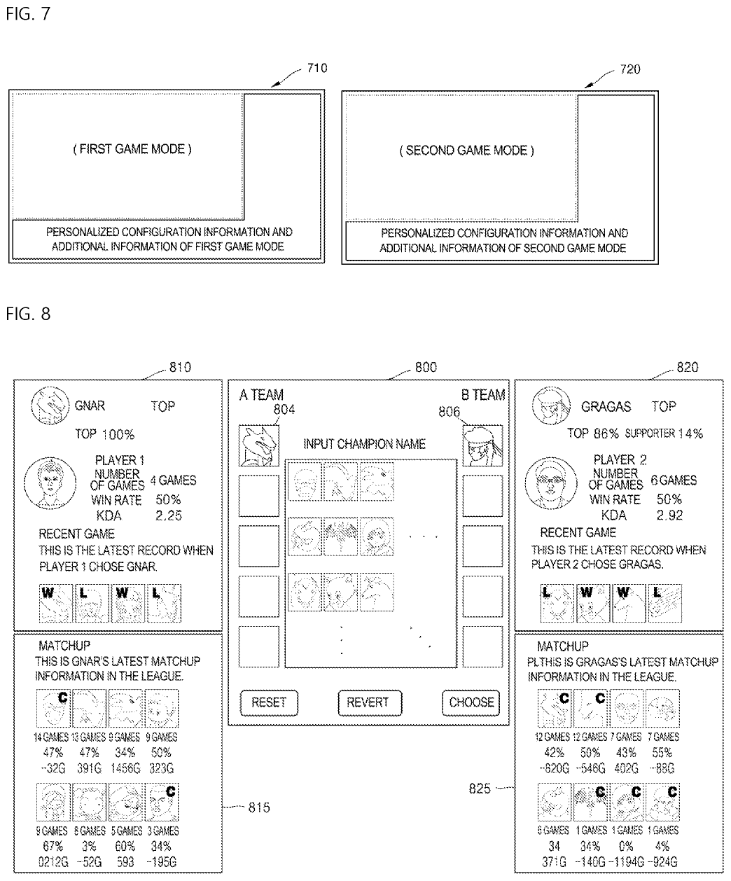

FIG. 7 is a diagram illustrating a method by which the server generates personalized configuration information on the basis of a game mode according to an embodiment.

In describing FIG. 7, for convenience of explanation, “League of Legends”, which is a team match game, will be described as an exemplary online game. “League of Legends” includes “Summoner's Rift” mode in which users battle on a map including three lanes and “Howling Abyss” mode in which users battle on a map including one lane. In addition, other game modes can be provided.

In one embodiment, a game mode identified from the game client executed in the second electronic device may be “Summoner's Rift” which is a first game mode 710. The server 2000 may receive information on the game mode executed in the game client from the second application and generate configuration information personalized to a user and additional information for playing a match of “Summoner's Rift” which is the first game mode 710. The server 2000 may provide the personalized configuration information and additional information generated with respect to the first game mode 710 to the second application.

In one embodiment, the game mode identified from the game client executed in the second electronic device may be “Howling Abyss” that is a second game mode 720. The server 2000 may receive information on the game mode executed in the game client from the second application and generate configuration information personalized to the user and additional information for playing a match of “Howling Abyss” which is the second game mode 720. The server 2000 may provide the personalized configuration information and additional information generated with respect to the second game mode 720 to the second application.

FIG. 8 is a diagram illustrating a method by which the server generates personalized configuration information according to an embodiment.

In describing FIG. 8, for convenience of explanation, “League of Legends”, which is a team match game, will be described as an exemplary online game, and a game character will be referred to as a “champion”.

Referring to FIG. 8, the server 2000 according to an embodiment may generate configuration information personalized to a user in the preliminary team composition stage before a match begins.

In one embodiment, a screen 800 for the preliminary team composition stage may display a match team of the user who participates in the match and champions 802 that can be selected by an opposing match team in the match. In the disclosed embodiment, the left columns of the champions 802 selectable in the match may indicate team members of the user's match team and right columns of the champions selectable in the match 802 may indicate team members of the opposing match team.

For example, the team match game may be a 5:5 team match. In this case, each of the user's match team and the opposing match team may be composed of first to fifth users. Additionally, the first user of the user's match team may select champion A 804 in the preliminary team composition stage, and the first user of the opposing match team may select champion B 806 in the preliminary team composition stage. In the same manner, the second to fifth users of each match team may select champions. The method by which the user's match team and the opposing match team select champions may be a cross-selection method in which the user's match team and the opposing match team alternately select champions to be included in each team. When the match begins, 10 champions can participate in the match and battle to destroy the opposing team in a 5:5 team match.

In one embodiment, the server 2000 may identify the game characters (champions) of the team members of the user's match team with which the user is matched and the game characters (champions) of the team members of the opposing match team.

The server 2000 may generate personalized configuration information on the basis of the identified game characters (champions) of the team members of the user's match team and the team members of the opposing match team.

In one embodiment, champions used in a match may be various types of champions. Types of champions may include, for example, warrior, assassin, wizard, tanker, ranged dealer, supporter, etc. In other words, there may be various types of candidate champions available in a match, and users in the preliminary team composition stage can select champions to participate in the match from among a total of N candidate champions (N being an integer of 1 or more). Therefore, even if the user selects the same champion, champions selected by team members of the user's match team and champions selected by team members of the opposing match team may be different for each match, and thus detailed setting parameters (for example, rune, spell, etc.) for the champion selected by the user need to be set differently.

In one embodiment, on the basis of the identified champions of the team members of the user's match team and the team members of the opposing match team, the server 2000 may obtain first statistical information related to match records of first users, which are other users using the champions, and generate personalized configuration information on the basis of the first statistical information.

In one embodiment, the server 2000 may obtain statistical information related to past match records in which the currently selected champions were used on the basis of the identified champions of the team members of the user's match team and the team members of the opposing match team. In this case, the match records corresponding to the statistical information related to the past match records in which the selected champions were used may be records of a match in which a predetermined number or more of the same champions as the champions selected in the current match were selected. For example, if there are 10 champions selected in the current match, the match records may be records of a match in which at least 5 or more identical champions among the 10 champions were selected.

In one embodiment, the server 2000 may generate personalized configuration information using an artificial intelligence model created through learning. For example, the server 2000 may use an artificial intelligence model that outputs personalized configuration information for the champion selected by the user on the basis of at least one of the champion selected by the user, champions selected by team members of the user's match team, or champions selected by team members of the opposing match team.

In another embodiment, the server 2000 may identify statistical information related to match records of members of the opposing match team of the user's match team. The server 2000 may obtain second statistical information related to match records of second users who participate in the match.

For example, the second statistical information may include statistical information 810 related to match records of the first user of the user's match team. In this case, statistical information such as the champion selected by the first user of the user's match team, win rate, number of matches, rating, or recent match records of the first user can be obtained. Additionally, the second statistical information may include statistical information 820 related to match records of the first user of the opposing match team. In this case, statistical information such as the champion selected by the first user of the opposing match team, win rate, number of matches, rating, or recent match records of the first user can be obtained.

The server 2000 may generate personalized configuration information on the basis of the identified statistical information related to the match records of the members of the user's match team and the match records of the members of the opposing match team. In addition, the server 2000 may additionally use records 815 of matches against champions with which “champion A” selected by the first user of the user's match team battled and records 825 of matches against champions with which “champion B” selected by the first user of the opposing match team battled.

In one embodiment, the server 2000 may generate personalized configuration information using an artificial intelligence model created through learning. For example, the server 2000 may use an artificial intelligence model that outputs personalized configuration information for the champion selected by the user on the basis of at least one of the champion selected by the user, the first statistical information, the second statistical information, or records of matches against champions with which champions selected by respective users battled.

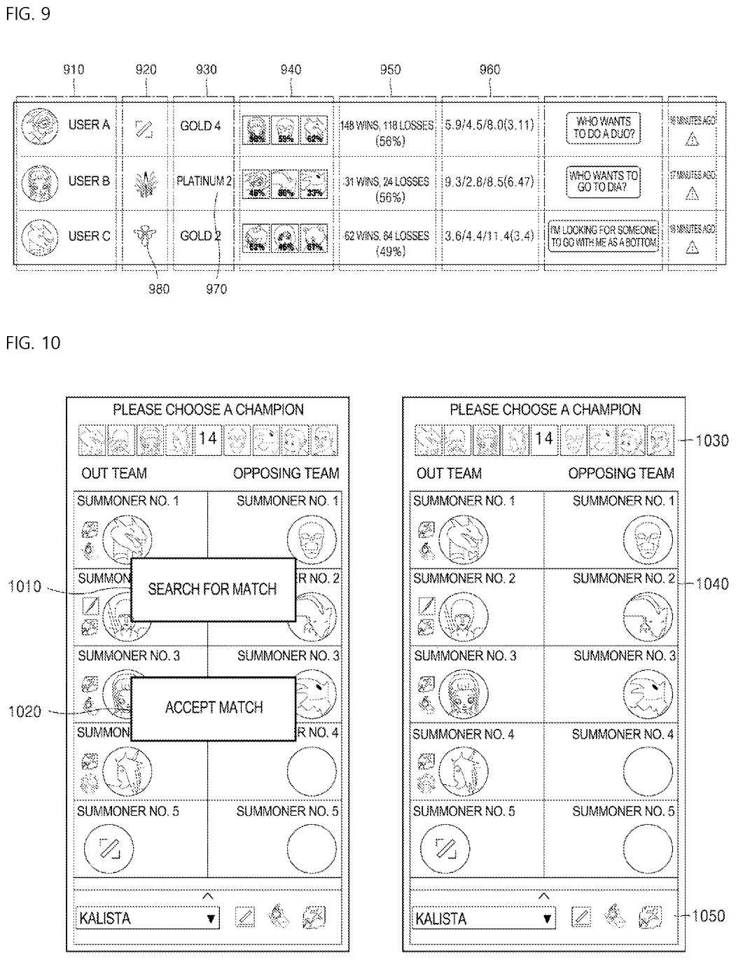

FIG. 9 is a diagram illustrating a method by which the server provides a user with information on team members who can participate in the same team as the user according to an embodiment.

The server 2000 according to an embodiment may obtain a list of other users registered as friends of the user. The server 2000 may generate information on team members who can participate in the match as the same team as the user on the basis of other skill level information and in-game position information included in the obtained list. The server 2000 may provide the information on the team members who can participate to at least one of the first application or the second application.

In one embodiment, the server 2000 may obtain game profile information of the user and generate information on team members who can participate in the same team as the user on the basis of the obtained game profile information of the user. The game profile information of the user may include at least one of the user's game tier, the champion the user mainly plays, the rune and spell of the champion, and the user's in-game position.

For example, if the user's game tier is “Gold 3” and the user's in-game position is “Supporter”, the server 2000 can generate information on user A 910 as a team member who can participate in the same team as the user. Since the in-game position 920 of user A 910 is “Mid”, it does not overlap with the user's in-game position “Supporter”, and the game tier 930 of user A 910 is “Gold 4” which is similar to the user's game tier “Gold 3”, and thus user A 910 may be another user who can participate in the same team as the user. The server 2000 may generate information on user A 910, including at least one of the primary champion 940, record 950, or rating 960 of user A.

In another example, the game tier 970 of another user B may be “Platinum 2”. In this case, user B may not be suitable to participate in the match due to the difference between the user's game tier “Gold 3” and the game tier. Accordingly, the server 2000 may not include information on user B in the information on team members who can participate as team members.

In another example, in the case of another user C, the in-game position 980 of user C is “Supporter”, and thus user C is not suitable to participate in the match with the user because the in-game position 980 of user C overlaps with the user's in-game position “Supporter”. Accordingly, the server 2000 may not include user C in the information on team members who can participate as team members.

In one embodiment, the server 2000 may search for and obtain a list of random users in addition to users included in the list of other users registered as friends of the user and generate information on team members who can participate as team members of the user. Since this is the same as the method of generating information on team members from a list of other users registered as friends of the user described above, description thereof will be omitted.

In one embodiment, the server 2000 may generate information on team members who can participate in the same team as the user using an artificial intelligence model created through learning. For example, the server 2000 may use an artificial intelligence model that outputs information on team members who can participate in the same team as the user on the basis of the game profile information of the user and game profile information of other users.

FIG. 10 is a diagram illustrating the first application managed by the server according to an embodiment.

In describing FIG. 10, for convenience of explanation, “League of Legends”, which is a team match game, will be described as an exemplary online game.

The server 2000 according to an embodiment may receive user inputs related to preliminary operations for the user to prepare for a match from the first application executed in the first electronic device used by the user. In this case, the preliminary operations for the user to prepare for a match may refer to operations performed by the user in match search/acceptance and preliminary team composition stages before the match begins. The server 2000 may receive the preliminary operations for the user to prepare for a match using the first application through the first electronic device and provide control information to the second application of the second electronic device such that the user can remotely control the game client executed in the second electronic device using the first electronic device.

In one embodiment, the server 2000 may provide a user interface for allowing the user to search for a match 910 to participate in the match to the first application. In this case, the user can input a match search command to participate in the match using the first application. The server 2000 may receive the user input for searching for a match from the first application and provide control information for the second application to control the game client to search for a match to the second application.

When a match is searched for, the server 2000 may transmit notification information for requesting that the user accept participation in the match to the first application and provide a user interface for accepting the match 920 to the first application. In this case, the user can input a match acceptance command 920 to participate in the searched match using the first application. The server 2000 may receive the user input for accepting the searched match from the first application and provide control information for the second application to control the game client to participate in the match to the second application.

When the user participates in the match, the server 2000 may provide a user interface through which the user can input parameters to be set before the start of the match in the preliminary team composition stage to the first application.

In one embodiment, the server 2000 may receive a user input through which the user bans a specific champion from being used in the preliminary team composition stage before the match begins using the first application and provide control information for the second application to control the game client to ban the champion from participating in the match to the second application. The server 2000 may provide a user interface 930 related to banned champions to the first application such that the user can check the banned champions using the first application.

In one embodiment, the server 2000 may receive a user input through which the user selects a specific champion in the preliminary team composition stage before the match begins using the first application and provide control information for the second application to control the game client to select a champion to participate in the match to the second application. In this case, according to the above-described embodiments, the server 2000 may also provide champion-related information, which is personalized configuration information, in order to recommend at least one champion to be selected by the user to participate in the match. The server 2000 may transmit the personalized configuration information to at least one of the first application or the second application such that the user can check the personalized configuration information using the first electronic device or the second electronic device. The server 2000 may provide a user interface 940 related to selected champions to the first application such that the user can check champions selected by the user's match team and the opposing match team using the first application.

In one embodiment, the server 2000 may receive a user input through which the user sets game parameters (e.g., rune, spells, etc.) to be used in the match using the first interface in the preliminary team composition stage before the match begins, and provide control information for the second application to control the game client to set the parameters to the second application. In this case, according to the above-described embodiments, the server 2000 may also provide personalized configuration information such as rune-related information and spell-related information in order to recommend parameters to be set by the user to participate in the match to the user. The server 2000 may transmit the personalized configuration information to at least one of the first application or the second application such that the user can check the personalized configuration information using the first electronic device or the second electronic device.

The server 2000 may provide a user interface 950 related to parameter setting to the first application such that the user can set parameters using the first application.

In addition, if the user does not apply a separate input to set parameters, the server 2000 may provide personalized configuration information generated by the server to the second application such that the second application controls the game client to automatically set the parameters.

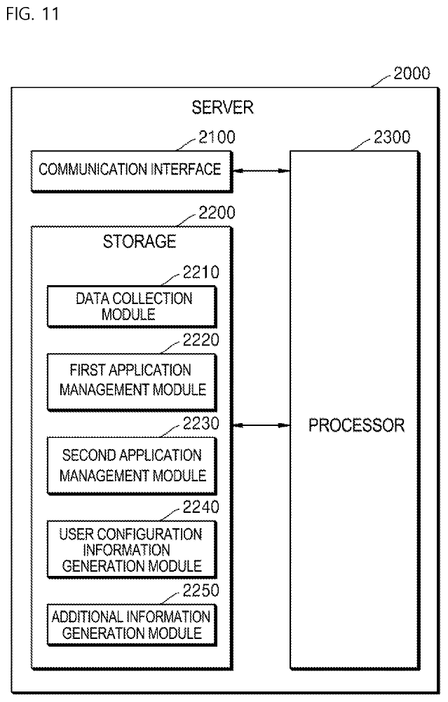

FIG. 11 is a block diagram showing a configuration of the server according to an embodiment.

The server 2000 according to an embodiment may include at least a communication interface 2100, a storage 2200, and a processor 2300.

The communication interface 2100 may perform data communication with a game server (not shown) under the control of the processor 2500. Additionally, the communication interface 2100 may perform data communication not only with a game server (not shown) but also with other electronic devices (e.g., the first electronic device and the second electronic device).

Instructions, data structures, and program code that can be read by the processor 2300 may be stored in the storage 2200. In the disclosed embodiments, operations performed by the processor 2300 may be implemented by executing program instructions or code stored in the storage 2200. In addition, data and program instruction code corresponding to a data collection module 2210, a first application management module 2220, a second application management module 2230, a user configuration information generation module 2240, and an additional information generation module 2250 may be stored in the storage 2200.

The processor 2300 can control the overall operations of the server 2000. For example, the processor may execute one or more instructions stored in the storage 2200 such that the server 2000 can perform overall operations for providing game-related services to the user.

In one embodiment, the processor 2300 may collect data necessary to provide services using data and instruction code related to the data collection module 2210. For example, the server 2000 may obtain first statistical information related to match records of first users, second statistical information related to match records of second users who have participate in a match, user statistical information related to match records of the user, etc.

In one embodiment, the processor 2300 may manage the first application using data and instruction code related to the first application management module 2220. In this case, the first application may be installed in the first electronic device, and the first electronic device may be a mobile device.

The first application management module 2220 may process a user command received from the first application. In this case, the user command may be a command related to preliminary operations remotely performed by the user to prepare for a match through a mobile terminal.

The first application management module 2220 may process game-related information obtained from a game client executed in the second electronic device in order to provide the game-related information to the first application. For example, if the first electronic device is a mobile device and the second electronic device is a desktop PC in which a game client is executed, the display screen of the first electronic device is smaller, and thus the amount of game-related information that can be displayed on the first electronic device may be less than the amount of game-related information that can be displayed on the second electronic device. The first application management module 2220 may select and process game-related information obtained from the second application to generate game-related information to be provided to the first application and provide the game-related information to the first application.

The first application management module 2220 may create a user interface of the first application. For example, if the first electronic device in which the first application is executed is a mobile device, the first application management module 2220 may create a user interface for providing game-related information to the display of the first application on the basis of game-related information to be provided to the first application. The server 2000 may provide the created user interface of the first application to the first application.

In one embodiment, the processor 2300 may manage the second application using data and instruction code related to the second application management module 2230. In this case, the second application may be installed in the second electronic device, and the second electronic device may be a desktop PC.

The second application management module 2230 may process user commands received from the second application. In this case, the user commands may be a command related to preliminary operations for the user to prepare for a match and a command related to in-game operations input by the user after the match starts.

The second application management module 2230 may generate control information for controlling a game client executed in the second electronic device.

In one embodiment, the second application management module 2230 may generate the control information for controlling the game client on the basis of a command related to preliminary operations remotely performed by the user to prepare for a match through the first electronic device and received from the first application of the first electronic device. The second application management module 2230 may provide the generated control information of the second application to the second application.

The second application management module 2230 may create a user interface of the second application. For example, if the second electronic device in which the second application is executed is a desktop PC, the second application management module 2230 may generate a user interface for providing personalized configuration information and additional information to the display of the second application on the basis of personalized configuration information and additional information to be provided to the second application, generated by the server.

The user configuration information generation module 2240 can generate configuration information personalized to a user. In one embodiment, the user configuration information generation module 2240 may generate configuration information personalized to the user on the basis of first statistical information of first users. Additionally, in one embodiment, the user configuration information generation module 2240 may generate configuration information personalized to the user on the basis of at least one of an identified game mode, statistical information related to match records of the user, a game character selected by the user, a game character of the user's match team, or a game character of an opposing match team. Since detailed description of the method of generating personalized configuration information has been given in the above-described embodiments, description of the same will be omitted.

The additional information generation module 2250 can generate additional information regarding a match team with which the user is matched. The additional information generation module 2250 may generate additional information regarding the match team with which the user is matched on the basis of second statistical information related to match records of team members of the match team with which the user is matched among second users participating in the match. Since the detailed description of the method of generating additional information has been given in the above-described embodiments, description of the same will be omitted.

The server 2000 according to an embodiment may provide at least one of personalized configuration information or additional information to the first application using the first application management module 2220. Additionally, the server 2000 may provide at least one of personalized configuration information or additional information to the second application using the second application management module 2230.

Meanwhile, the block diagram of the server 2000 shown in FIG. 11 is a block diagram for one embodiment. The components in the block diagram may be integrated, added, or omitted depending on the specifications of each device actually implemented. That is, two or more components may be combined into one component, or one component may be subdivided into two or more components as necessary. In addition, the function performed by each block is for explaining the embodiments, and the specific operations or devices do not limit the scope of the present invention.

The operating method of the server according to an embodiment may be implemented in the form of program instructions that can be executed through various computer means and recorded on a computer-readable medium. The computer-readable medium may contain program instructions, data files, data structures, and the like alone or in combination. Program instructions recorded on the medium may be specially designed and constructed for the present invention or may be known to and usable by those skilled in the art of computer software.

Additionally, the operating method of the server according to the disclosed embodiments may be provided by being contained in a computer program product. Computer program products can be traded as commodities between sellers and buyers. Computer program products may include S/W programs and computer-readable storage media in which S/W programs are stored.

Although the embodiments have been described in detail above, the scope of the present invention is not limited thereto, and various modifications and improvements made by those skilled in the art using the basic concept of the present invention defined in the following claims are also included in the scope of the present invention.

1. A server comprising:
a communication interface;
a processor; and
a memory in which instructions executable by the processor are stored,
wherein the processor is configured to, by executing the instructions;
obtain first statistical information related to match records of a plurality of first users using a team match game;
receive, from a first application, user input related to preliminary operations performed by a user to prepare for a match;
obtain second statistical information related to match records of second users participating in the match;
generate configuration information personalized to the user of the first application on the basis of the first statistical information;
generate additional information regarding a match team with which the user is matched on the basis of the second statistical information;
provide control information for controlling a game client to a second application on the basis of the user input; and
provide at least one of the personalized configuration information or the additional information to the second application.

2. The server of claim 1, wherein the first application is installed in a first electronic device, and the second application is installed in a second electronic device.

3. The server of claim 1, wherein the processor is configured to:
provide at least one of the personalized configuration information or the additional information to the first application; and
to synchronize information provided to the first application and the second application.

4. The server of claim 1, wherein the processor is configured to:
receive authentication information of the user from the first application; and
to provide control information for controlling the game client to which the authenticated user is connected to the second application on the basis of the authentication information of the user.

5. The server of claim 2, wherein the processor is configured to:
acquire game client location information of the game client displayed on a display of the second electronic device; and
generate second application location information for displaying the second application on the second electronic device on the basis of the game client location information.

6. The server of claim 1, wherein the processor is configured to:
acquire game profile information of the user; and
determine a plurality of first users having characteristics similar to characteristics of the user on the basis of the game profile information of the user.

7. The server of claim 1, wherein the processor is configured to:
identify a game mode of the match in which the user has participated; and
generate configuration information personalized to the user such that the personalized configuration information corresponds to the identified game mode.

8. The server of claim 1, wherein the processor is configured to:
obtain user statistical information related to match records of the user; and
generate personalized configuration information indicating parameters set by the user to participate in the match on the basis of the first statistical information and the user statistical information.

9. The server of claim 1, wherein the processor is configured to generate additional information including at least one of a tier of each member of the match team with which the user is matched, a win rate of each team member, whether each team member matches a main position, or an expected win rate of the match team with which the user is matched.

10. The server of claim 1, wherein the processor is configured to:
receive, from the first application, a game character selected by the user and parameters set by the user to participate in the match with the selected game character; and
generate the personalized configuration information on the basis of the game character selected by the user and the parameters set by the user to participate in the match with the selected game character.

11. The server of claim 10, wherein the processor is configured to:
identify game characters of team members of the match team with which the user is matched and game characters of team members of the opposing match team; and
generate personalized configuration information on the basis of the identified game characters of the team members of the match team and the team members of the opposing match team.

12. The server of claim 10, wherein the processor is configured to:
identify statistical information related to match records of the team members of the opposing match team of the match team with which the user is matched; and
generate personalized configuration information on the basis of the identified statistical information related to the match records of the team members of the opposing match team.

13. The server of claim 1, wherein the processor is configured to:
obtain a list of other users registered as friends of the user; and
generate information on a team member who is able to participate in the match as the same team as the user on the basis of skill level information and in-game position information of other users included in the list.

14. The server of claim 1, wherein the processor is configured to:
receive, from the first application, a match search request input by the user to participate in the match; and
transmit, to the first application, notification information for requesting that the user accept participation in the match when the match has been searched for.

15. An operating method of a server, comprising:
obtaining first statistical information related to match records of a plurality of first users using a team match game;
receiving, from a first application, user input related to preliminary operations performed by a user to prepare for a match;
obtaining second statistical information related to match records of second users participating in the match;
generating configuration information personalized to the user of the first application on the basis of the first statistical information;
generating additional information regarding a match team with which the user is matched on the basis of the second statistical information;
providing control information for controlling a game client to a second application on the basis of the user input; and
providing at least one of the personalized configuration information or the additional information to the second application.

16. A computer program stored in a recording medium to perform:
obtaining first statistical information related to match records of a plurality of first users using a team match game;
receiving, from a first application, user input related to preliminary operations performed by a user to prepare for a match;
obtaining second statistical information related to match records of second users participating in the match;
generating configuration information personalized to the user of the first application on the basis of the first statistical information;
generating additional information regarding a match team with which the user is matched on the basis of the second statistical information;
providing control information for controlling a game client to a second application on the basis of the user input; and
providing at least one of the personalized configuration information or the additional information to the second application.

17. An electronic device comprising:
a communication interface;
a processor; and
a memory in which instructions executable by the processor are stored,
wherein the processor is configured to, by executing the instructions:
execute a game client providing a team match game on the electronic device;
receive, from a server, personalized configuration information indicating parameters set by a user to participate in a match and additional information regarding a match team to which the user is matched, wherein the personalized configuration information is generated based on first statistical information related to match records of a plurality of first users using the team match game, and the additional information is generated based on second statistical information related to match records of second users who have participated in the current match in which the user has participated;
display the personalized configuration information and the additional information; and
control the game client such that the personalized configuration information is applied to the game client.
